(19) United States
(12) Patent Application Publication
(10) Pub. No.: US 2018/0199384 A1
(43) Pub. Date: Jul. 12, 2018

(54) NETWORK-INITIATED DETACH PROCEDURES IN A NEUTRAL HOST NETWORK

(71) Applicant: Alcatel-Lucent USA Inc., Murray Hill, NJ (US)

(72) Inventor: Semyon Mizikovsky, Morganville, NJ (US)

(21) Appl. No.: 15/403,573

(22) Filed: Jan. 11, 2017

(51) Int. Cl. H04W 76/06; H04W 16/14

(52) U.S. Cl. CPC H04W 76/068; H04W 88/16; H04W 16/14

(57) ABSTRACT

A neutral host network is configured to provide services supported by any one or more of multiple Participating Service Providers (PSPs) to user equipment in an unlicensed frequency band. The neutral host network includes a neutral host gateway configured for communication with at least one external network, a mobility management entity (MME), and a local authentication, authorization, and accounting (AAA) server configured to determine that a session involving the user equipment is to be detached from the neutral host network. The local AAA server is also configured to transmit, to the neutral host gateway, a first message to initiate session detach of the session involving the user equipment. The neutral host gateway can be configured to transmit a second message to the MME in response to receiving the first message. The MME is configured to perform session detach for the session in response to receiving the second message.

### BACKGROUND

A neutral host network supports wireless connectivity to user equipment over an unlicensed frequency band and provides services to the user equipment from one or more Participating Service Providers (PSPs). The operator of the neutral host network maintains agreements with PSPs for providing access resources to the subscribers of these PSPs. The neutral host network is agnostic with regard to the PSPs and any PSP can authorize a subscriber's user equipment to access services via the neutral host network. Each user equipment is able to discover the available PSPs in a list of PSP identifiers (PSP-IDs) maintained by the neutral host network. The user equipment can then automatically select a PSP based on a match between its PSP subscriptions and the available PSPs, as well as priorities associated with the PSPs. Users can also manually select an available PSP via a user interface. The neutral host network supports an online sign-up process that allows user equipment to subscribe to an available PSP if the user equipment is not already subscribed to the available PSP. For example, the user equipment can establish a guest session with the neutral host network without a subscription, subscribe to an available PSP, and then disconnect the guest session prior to establishing a new session on the basis of the new subscription with the available PSP.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a diagram illustrating a message flow that is used to initiate session detach in a neutral host network according to some embodiments.

FIG. 3 is a diagram illustrating a message flow that is used to initiate session detach in a neutral host network in response to signaling from an external AAA server according to some embodiments.

FIG. 4 is a diagram illustrating a message flow that is used to initiate detach of a guest session in a neutral host network in response to completing online sign-up according to some embodiments.

FIG. 5 is a block diagram of a neutral host network according to some embodiments.

### DETAILED DESCRIPTION

A neutral host network includes an access point to provide wireless connectivity to user equipment over an air interface in an unlicensed frequency band, a mobility management entity (NH-MME) to support mobility functions for the user equipment, and a neutral host network gateway (NH-GW) to connect the neutral host network to external networks. The neutral host network does not support subscription-related functionality and all subscription-related functionality is performed by a corresponding PSP. For example, each PSP includes an authentication, authorization, and accounting (AAA) server to maintain subscriptions, authenticate user equipment, authorize sessions, and account for resource usage by the user equipment. The neutral host network communicates with the AAA servers in the PSPs via a proxy (or local) AAA server implemented in the neutral host network. Since the neutral host network does not support subscription-related functionality and the user equipment does not subscribe to the neutral host network, the neutral host network does not include (or has access to) a home subscriber server (HSS) or other entity that supports a master user database of user subscription information. Similarly, the neutral host network lacks a policy charging and rules function (PCRF) to support the creation of rules and to make policy decisions for user equipment that are accessing the neutral host network.

Conventional networks (as defined by 3GPP) are able to initiate a session detach procedure to detach sessions associated with user equipment, e.g., based on session-specific control policies, current resource usage by the user equipment, and the like. For example, the HSS and PCRF in a conventional network can initiate session detach by transmitting an abort session request or a re-authentication request to an MME in response to the session exceeding a resource usage limit. However, as discussed above, a neutral host network does not include HSS or PCRF functionality. The MME implemented in the neutral host network (NH-MME) is not aware of session-specific control policies or current resource usage for sessions. The NH-MME in the neutral host network is therefore unable to initiate session detach based on these criteria. The NH-GW is also unable to initiate session detach for similar reasons. The user equipment is able to initiate session detach from the neutral host network but it is not safe to rely on the user equipment to initiate session detach because the user equipment can (intentionally or inadvertently) fail to detach sessions according to the control policies or resource usage limits established by the PSP that is supporting the session.

Network-initiated session detach can be implemented in a neutral host network by configuring a local AAA implemented in the neutral host network to initiate session detach for a session associated with a user equipment that is accessing the neutral host network over an air interface to an access point in the neutral host network. Some embodiments of the local AAA are configured to initiate the session detach based on certain control policies or resource usage time limits stored by the local AAA. However, the local AAA is unaware of the volume-based resource utilization of the user equipment during a session. The volume-based resource utilization can be only determined by an NH-GW, which routes session-specific user plane data. Nevertheless, the local AAA is fully aware of the session length and is therefore able to enforce the time limits for the session based on local policies or as prescribed by the PSP. For example, the local AAA can monitor resource usage time limits for a user equipment during a session and initiate a session detach to terminate the session in response to the monitored resource usage exceeding a resource usage time limit for the user equipment or the session. Some embodiments of the local AAA are configured to initiate the session detach in response to signaling received from an external AAA associated with a PSP that supports the session with the user equipment.

Initiating the session detach includes transmitting an abort session request to terminate the session or a re-authentication request to terminate a specific service data flow, which can be indicated in an attribute value pair transmitted with the re-authentication request. Thus, the session detach can include detaching an entire session or a portion of the session, e.g., a service data flow supported by the session. The session detach request is transmitted from the local AAA to the NH-MME implemented in the neutral host network and the NH-MME performs the session detach according to previously standardized procedures. Some embodiments of the local AAA are configured to initiate session detach for guest sessions that are not associated with a subscription to a PSP, such as guest sessions that are used to establish a subscription to the PSP. For example, the external AAA associated with the PSP receives an indication in response to the PSP completing the subscription process with a user equipment. The external AAA can then send a session termination request to the local AAA, which initiates the session detach in response to receiving the session termination request.

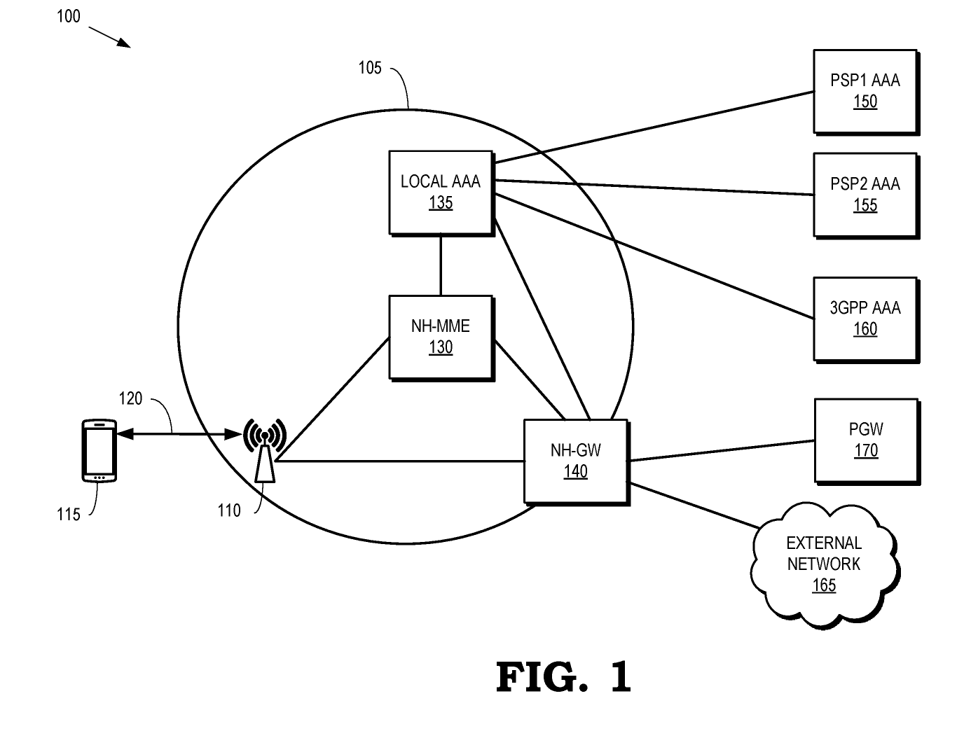

FIG. 1 is a block diagram of a wireless communication system 100 according to some embodiments. The wireless communication system 100 includes a neutral host network 105 for providing services supported by multiple PSPs. As discussed herein, the neutral host network 105 is not limited to supporting a single service provider that owns or operates the neutral host network 105. Instead, the neutral host network 105 is configured to convey information associated with services provided by any one of the multiple PSPs that have established relationships with the neutral host network 105. For example, operators of different PSPs can establish agreements with operators of the neutral host network 105 so that the PSPs can use the resources of the neutral host network 105 to provide services to subscribers to the services provided by the PSP.

The neutral host network 105 includes one or more base stations or access points 110 that are configured to provide wireless connectivity to one or more user equipment 115 over an air interface 120. Some embodiments of the neutral host network 105 use unlicensed frequency bands supported by the access points 110 and the user equipment 115 to provide services to the user equipment 115. Unlicensed frequency bands are portions of the radiofrequency spectrum that do not require a license for use and may therefore be used by any device to transmit or receive radiofrequency signals. For example, the Unlicensed National Information Infrastructure (UNIT) is formed of portions of the radio spectrum that include frequency bands in the range of 5.15 GHz to 5.825 GHz. For another example, the industrial, scientific, and medical (ISM) radio bands are portions of the radio spectrum that are reserved internationally for unlicensed communication. The ISM radio bands include bands with a center frequency of 2.4 GHz and a bandwidth of 100 MHz, a center frequency of 5.8 GHz and a bandwidth of 150 MHz, and a center frequency of 24.125 GHz and a bandwidth of 250 MHz, among other frequency bands. Unlicensed frequency bands can be contrasted to licensed frequency bands that are licensed to a particular service provider and can only be used for wireless communication that is authorized by the service provider or license holder.

The neutral host network 105 also includes a mobility management entity (NH-MME) 130 that implements control plane and data plane stacks to support an interface with the access point 110, as well as supporting interfaces with other entities as discussed herein. For example, the NH-MME 130 can support a stream control transmission protocol (SCTP) that utilizes Internet Protocol (IP) to support delivery of packets over the interface to the access point 110. The NH-MME 130 can also support an S1 application part signaling service for bearer management, context transfer, mobility, paging, and the like.

The neutral host network 105 also includes a local authentication, authorization, and accounting (AAA) server 135. The local AAA server 135 does not maintain subscriptions, authenticate user equipment, authorize sessions, or accounts for resource usage by the user equipment 115. Instead, the local AAA server 135 acts as a proxy for the authentication, authorization, and accounting performed for the user equipment 115 by AAA servers associated with the PSPs (e.g., external AAA servers 150, 155, 160 described below) that use the resources of the neutral host network 105.

The neutral host network 105 further includes a neutral host gateway 140 that provides an interface for accessing the resources of the neutral host network 105. The NH-MME 130, the local AAA server 135 and the neutral host gateway 140 implement control plane or data plane stacks to support interfaces with each other. For example, the NH-MME 130 and the local AAA server 135 are connected by an interface, the NH-MME 130 and the neutral host gateway 140 are connected by an interface, and the local AAA server 135 and the neutral host gateway 140 are connected by an interface.

Some embodiments of the local AAA server 135 and the neutral host gateway 140 implement control plane or data plane stacks to support interfaces with entities that are external to the neutral host network 105. For example, the local AAA server 135 supports interfaces with external AAA servers such as a PSP1 AAA server 150 that is associated with a first service provider, PSP1, and a PSP2 AAA server 155 that is associated with a second service provider, PSP2. The local AAA server 135 also supports an interface with an external 3GPP AAA server 160 for an external network 165. The local AAA server 135 can therefore act as a proxy for the PSP1 AAA server 150, the PSP2 AAA server 155, and the 3GPP AAA server 160. For another example, when the neutral host network is using resources of the 3GPP evolved packet core as a trusted or untrusted non-3GPP network access, the neutral host gateway 140 supports interfaces with a packet data node (PDN) gateway (PGW) 170 for an external 3GPP EPC network (not shown in FIG. 1). The neutral host gateway 140 also supports interfaces with one or more other external networks 165 so that data or signaling can be conveyed between the neutral host network 105 and the external network 165.

As discussed herein, the neutral host network 105 does not include (or have access to) a home subscriber server (HSS) or other entity that supports a master user database of user subscription information. Moreover, the neutral host network 105 does not include a policy charging and rules function (PCRF) to support the creation of rules or to make policy decisions for user equipment 115 that are accessing the neutral host network 105. Thus, these entities (the HSS and PCRF) are not available to perform network-initiated session detach of sessions associated with the services provided to the user equipment 115 by one or more PSPs. Therefore, the local AAA server 135 is configured to determine that a session involving the user equipment 115 is to be detached from the neutral host network 105. The local AAA server 135 can determine that the session is to be detached based on policies, rules, or resource usage limits stored in the local AAA server 135 or in response to signaling received from the external AAA servers 150, 155, 160. The local AAA server 135 transmits messages to initiate the session detach to the neutral host gateway 140, which can forward the messages (or other signaling) to the MME 130 to begin the session detach process.

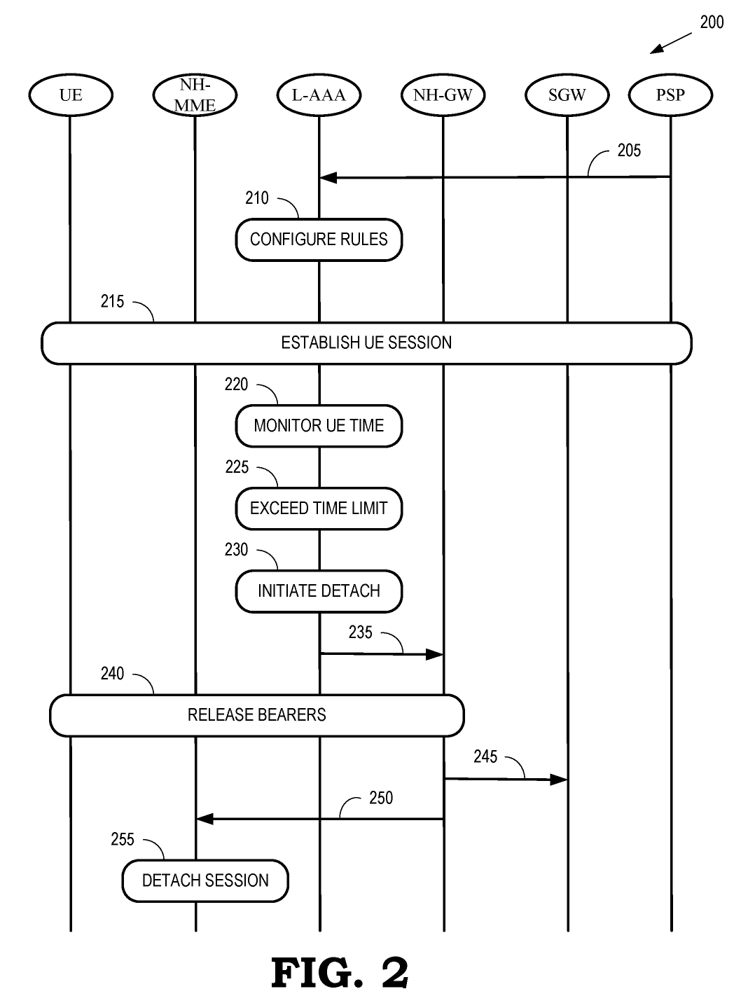

FIG. 2 is a diagram illustrating a message flow 200 that is used to initiate session detach in a neutral host network according to some embodiments. The message flow 200 includes actions performed by, and messages transmitted between, a user equipment (UE), an NH-MME, a local AAA server, and a neutral host gateway in the neutral host network and a serving gateway and PSP that are external to the neutral host network. The message flow 200 can therefore be used by some embodiments of the wireless communication system 100 shown in FIG. 1. In the illustrated embodiment, the PSP has already negotiated an agreement with an operator of the neutral host network to allow the PSP to provide services using the resources of the neutral host network. Information indicating the identities of the PSPs that have established relationships with the neutral host network and are authorized to use the resources of the neutral host network can be stored in the local AAA server. The user equipment has also subscribed to the PSP to receive the services.

Prior to establishing a session with the user equipment to provide services, the PSP transmits a message 205 to the local AAA server including information used to configure the local AAA server. Some embodiments of the message 205 include information defining rules or policies used by the local AAA server to determine when to initiate session detach. The policy used by the local AAA server can include a local policy established for the neutral host network or a PSP policy prescribed by one of the multiple PSPs. The message 205 can also include information indicating resource usage limits such as time limits associated with sessions. Some embodiments of the message 205 are defined according to the protocol specified by section 4.5.2 of 3GPP TS 29.212, which is incorporated herein by reference in its entirety. Using the resource usage limits such as time limits associated with sessions from the message 205, the local AAA server can compare the elapsed times associated with the session to the time limits to determine when to initiate session detach. The local AAA server configures the rules at block 210. For example, the local AAA server can store the rules, policies, time limits, or other information for later use.

The user equipment establishes a session (at block 215) to receive services provided by the PSP. In response to determining that the user equipment has established the session, the local AAA server begins monitoring the elapsed time of the session at block 220. As long as the elapsed time is less than a time limit associated with the session, the local AAA server allows the session to proceed. At block 225, the local AAA server determines that the elapsed time has exceeded the time limit for the session. In response to determining that the elapsed time exceeds the time limit, the local AAA server initiates session detach of the session established between the user equipment and the PSP at block 230. Some embodiments of the local AAA server are also able to initiate session detach in response to detecting other events such as the user equipment consuming all of its available credit needed to receive the service provided by the PSP, low resource availability in the neutral host network, session reconfiguration, and the like.

The local AAA server then transmits a message 235 to the neutral host gateway indicating that session detach has been initiated. The message 235 includes information identifying the session that is to be detached and can also include other information such as an attribute value pair (AVP) indicating the cause of the detach (e.g., time limit exceeded). For example, the message 235 can be an abort command defined according to 3GPP TS 29.214, which is incorporated herein by reference in its entirety. Section 5.6.7 of 3GPP TS 29.214 specifies the abort session request command as follows:

5.6.7 Abort-Session-Request (ASR) command

```
The ASR command, indicated by the Command-Code field set to 274 and
the ‘R’ bit set in the Command Flags field, is sent by the PCRF to inform
the AF that bearer for the established session is no longer available.
Message Format:
<AS-Request> : := < Diameter Header: 274, REQ, PXY >
  < Session-Id >
  [ DRMP ]
  { Origin-Host }
  { Origin-Realm }
  { Destination-Realm }
  { Destination-Host }
  { Auth-Application-Id }
  [ OC-Supported-Features ]
  { Abort-Cause }
  [ Origin-State-Id ]
* [ Proxy-Info ]
* [ Route-Record ]
* [ AVP ]
```

Some embodiments of the local AAA server are also able to detach individual service data flows within a session instead of detaching the entire session. For example, the message 235 can be a reauthorization request defined according to 3GPP TS 29.214. Section 5.6.3 of 3GPP TS 29.214 specifies the reauthorization request as follows:

5.6.3 Re-Auth-Request (RAR) command

```
The RAR command, indicated by the Command-Code field set to 258 and
the ‘R’ bit set in the Command Flags field, is sent by the PCRF to the AF
in order to indicate an Rx specific action.
Message Format:
<RA-Request> : := < Diameter Header: 258, REQ, PXY >
    < Session-Id >
    [ DRMP ]
    { Origin-Host }
    { Origin-Realm }
    { Destination-Realm }
    { Destination-Host }
    { Auth-Application-Id }
    { Specific-Action }
    [ OC-Supported-Features ]
  * [ Access-Network-Charging-Identifier ]
    [ Access-Network-Charging-Address ]
    [ AN-GW-Address ]
    [ AN-Trusted ]
  * [ Flows ]
  * [ Subscription-Id ]
    [ Abort-Cause ]
    [ IP-CAN-Type ]
    [ NetLoc-Access-Support ]
    [ RAT-Type ]
    [ Sponsored-Connectivity-Data ]
      [ 3GPP-User-Location-Info ]
      [ User-Location-Info-Time ]
    [ 3GPP-MS-TimeZone ]
  * [ RAN-NAS-Release-Cause ]
    [ 3GPP-SGSN-MCC-MNC ]
    [ TWAN-Identifier ]
    [ TCP-Source-Port ]
    [ UDP-Source-Port ]
    [ UE-Local-IP-Address ]
    [ Origin-State-Id ]
  * [ Class ]
  * [ Proxy-Info ]
  * [ Route-Record ]
  * [ AVP ]
```

In response to the message 235, bearers used to support the session (or a particular service data flow within the session) are deactivated and released at block 240. In some embodiments, bearer deactivation and bearer release is performed according to the protocols described in section 5.4.4 of 3GPP TS 29.401, which is incorporated herein by reference in its entirety.

The neutral host gateway transmits a message 245 to the serving gateway indicating release of the bearers. Some embodiments of the message 245 are formed according to the protocols described in 3GPP TS 29.401. The neutral host gateway also transmits a message 250 to the MME to indicate that session detach has been initiated. In response to receiving the message 250, the MME detaches the session at block 255. Some embodiments of the MME detach the session according to the protocols described in section 5.3.8.3 of 3GPP TS 29.401.

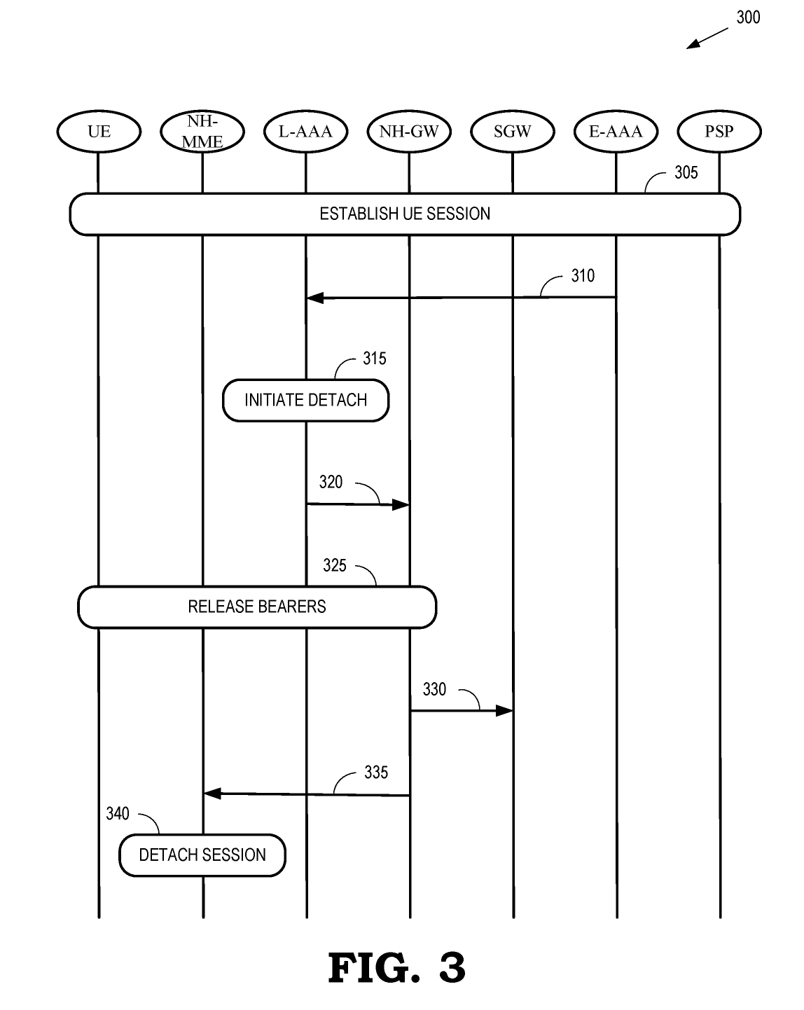

FIG. 3 is a diagram illustrating a message flow 300 that is used to initiate session detach in a neutral host network in response to signaling from an external AAA server according to some embodiments. The message flow 300 includes actions performed by, and messages transmitted between, a user equipment (UE), an MME, a local AAA server, and a neutral host gateway in the neutral host network, and a serving gateway, an external AAA server, and a PSP that are external to the neutral host network. The message flow 300 can therefore be used by some embodiments of the wireless communication system 100 shown in FIG. 1. In the illustrated embodiment, the PSP has already negotiated an agreement with an operator of the neutral host network to allow the PSP to provide services using the resources of the neutral host network. Information indicating the identities of the PSPs that have established relationships and are authorized to use the resources of the neutral host network can be stored in the local AAA server. The user equipment has also subscribed to the PSP to receive the services.

The user equipment establishes a session (at block 305) to receive services provided by the PSP. Although not depicted in FIG. 3, some embodiments of the local AAA server can monitor an elapsed time of the session in response to determining that the user equipment has established the session, as shown in FIG. 2.

The external AAA server transmits a message 310 to the local AAA server indicating that the session (or a particular service data flow supported by the session) is to be detached. Some embodiments of the external AAA server are able to determine that the session is to be detached based on session-specific control policies or current resource usage for sessions.

In response to receiving the message 310, the local AAA server initiates session detach of the session established between the user equipment and the PSP at block 315. The local AAA server then transmits a message 320 to the neutral host gateway indicating that session detach has been initiated. The message 320 includes information identifying the session that is to be detached and can also include other information such as an attribute value pair (AVP) indicating the cause of the detach (e.g., time limit exceeded). For example, the message 320 can be an abort command to detach a session or a reauthorization request to detach a particular service data flow within a session, as defined according to 3GPP TS 29.214.

In response to the message 320, bearers used to support the session (or a particular service data flow within the session) are deactivated and released at block 325. In some embodiments, bearer deactivation and bearer release is performed according to the protocols described in section 5.4.4 of 3GPP TS 29.401. The neutral host gateway transmits a message 330 to the serving gateway indicating release of the bearers. Some embodiments of the message 330 are formed according to the protocols described in 3GPP TS 29.401. The neutral host gateway also transmits a message 335 to the NH-MME to indicate that session detach has been initiated. In response to receiving the message 335, the NH-MME detaches the session at block 340. Some embodiments of the NH-MME detach the session according to the protocols described in section 5.3.8.3 of 3GPP TS 29.401.

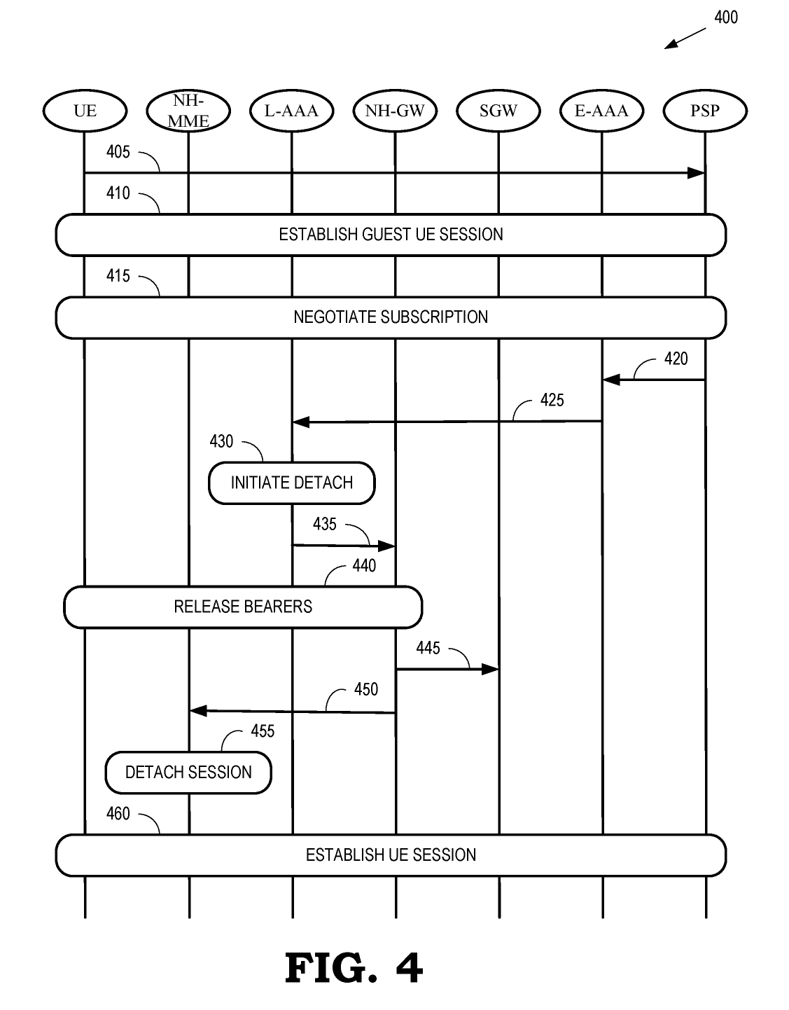

FIG. 4 is a diagram illustrating a message flow 400 that is used to initiate detach of a guest session in a neutral host network in response to completing online sign-up according to some embodiments. The message flow 400 includes actions performed by, and messages transmitted between, a user equipment (UE), an MME, a local AAA server, and a neutral host gateway in the neutral host network, and a serving gateway, an external AAA server, and a PSP that are external to the neutral host network. The message flow 300 can therefore be used by some embodiments of the wireless communication system 100 shown in FIG. 1. In the illustrated embodiment, the PSP has already negotiated an agreement with an operator of the neutral host network to allow the PSP to provide services using the resources of the neutral host network. Information indicating the identities of the PSPs that have established relationships and are authorized to use the resources of the neutral host network can be stored in the local AAA server. However, the user equipment has not yet subscribed to the PSP to receive the services.

The user equipment transmits a message 405 to request establishment of a guest session so that the user equipment can perform online sign-up to subscribe to one or more services provided by the PSP. As used herein, the term “guest session” refers to a session that allows the user equipment to communicate with the PSP via the neutral host network without requiring the user equipment to have an existing subscription with the PSP. At block 410, the user equipment and the PSP establish the guest session so that the user equipment and the PSP are able to communicate via the neutral host network. At block 415, the user equipment and the PSP negotiate a subscription, e.g., a subscription that allows the user equipment to receive one or more services provided by the PSP.

The PSP transmits a message 420 to the external AAA server in response to the PSP and the user equipment successfully negotiating the subscription. Some embodiments of the message 420 include information identifying the user equipment and parameters of the subscription, as well as rules, policies, resource usage limits, time limits, and the like for sessions (or service data flows within sessions) established by the user equipment. In response to receiving the message 420 indicating that the subscription negotiation is complete, the external AAA server transmits a message 425 to the local AAA server to indicate that the subscription has been successfully negotiated and the guest session can be detached.

In response to receiving the message 425, the local AAA server initiates session detach of the session established between the user equipment and the PSP at block 430. The local AAA server then transmits a message 435 to the neutral host gateway indicating that session detach has been initiated. The message 435 includes information identifying the session that is to be detached and can also include other information such as an attribute value pair (AVP) indicating the cause of the detach (e.g., time limit exceeded). For example, the message 435 can be an abort command or a reauthorization request defined according to 3GPP TS 29.214,

In response to the message 435, bearers used to support the session (or a particular service data flow within the session) are deactivated and released at block 440. In some embodiments, bearer deactivation and bearer release is performed according to the protocols described in section 5.4.4 of 3GPP TS 29.401. The neutral host gateway transmits a message 445 to the serving gateway indicating release of the bearers. Some embodiments of the message 445 are formed according to the protocols described in 3GPP TS 29.401. The neutral host gateway also transmits a message 450 to the NH-MME to indicate that session detach has been initiated. In response to receiving the message 450, the NH-MME detaches the session at block 455. Some embodiments of the NH-MME detach the session according to the protocols described in section 5.3.8.3 of 3GPP TS 29.401.

The user equipment establishes a new session based on the subscription with the PSP at block 460 after the session detaching at block 455. Some embodiments of the session establishment performed at block 460 correspond to session establishment at block 215 shown in FIG. 2 or session establishment at block 305 shown in FIG. 3. Some embodiments of the neutral host network require that the user equipment be detached from the network before accessing the neutral host network with newly provisioned credentials, such as the credentials associated with the subscription negotiated at block 415.

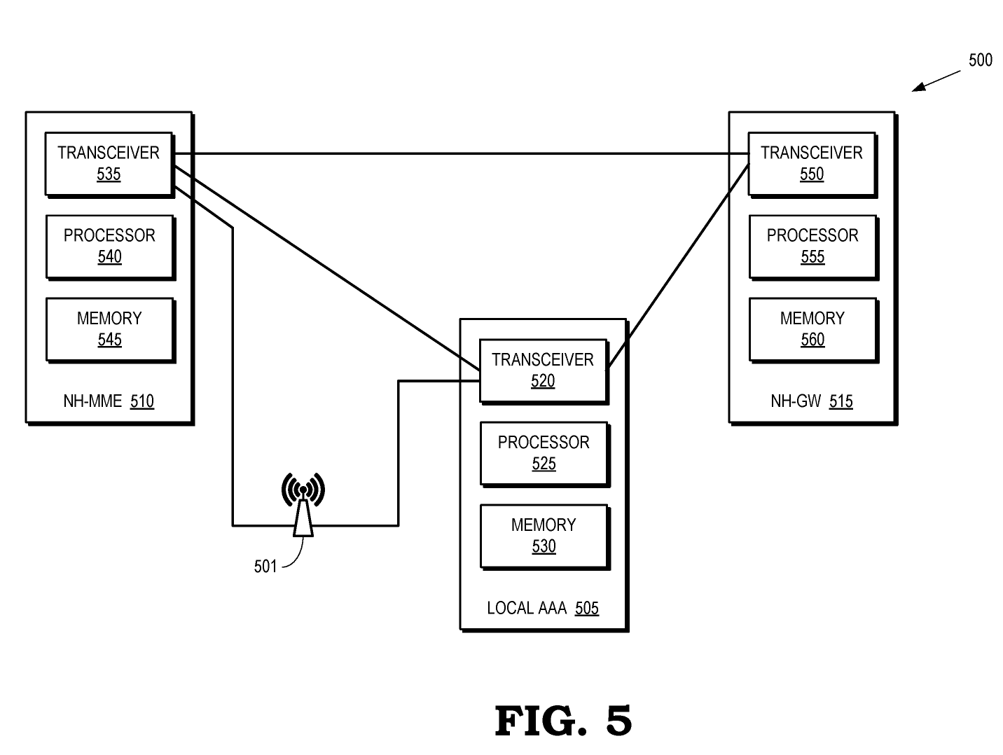

FIG. 5 is a block diagram of a neutral host network 500 according to some embodiments. The neutral host network 500 includes a neutral host radio access part that consists of a one or more access points 501 and an NH-MME 510. The neutral host network 500 also includes a neutral host core that includes a local AAA server 505 and a neutral host gateway 515. The neutral host network 500 can therefore be implemented in some embodiments of the neutral host network 105 shown in FIG. 1.

The local AAA server 505 includes a transceiver 520 for transmitting and receiving signals. The transceiver 520 can implement one or more interfaces to entities internal to or external to the neutral host network 500, as discussed herein. Some embodiments of the transceiver 520 are therefore able to transmit and receive messages described in the message flow 200 shown in FIG. 2, the message flow 300 shown in FIG. 3, and the message flow 400 shown in FIG. 4. The transceiver 520 can be implemented as a single integrated circuit (e.g., using a single ASIC or FPGA) or as a system-on-a-chip (SOC) that includes different modules for implementing the functionality of the transceiver 520. The local AAA server 505 also includes a processor 525 and a memory 530. The processor 525 can be used to execute instructions stored in the memory 530 and to store information in the memory 530 such as the results of the executed instructions. Some embodiments of the processor 525 and the memory 530 are therefore able to perform actions described in the message flow 200 shown in FIG. 2, the message flow 300 shown in FIG. 3, and the message flow 400 shown in FIG. 4.

The NH-MME 510 includes a transceiver 535 for transmitting and receiving signals. The transceiver 535 can implement one or more interfaces to entities internal to the neutral host network 500, as discussed herein. Some embodiments of the transceiver 535 are therefore able to transmit and receive messages described in the message flow 200 shown in FIG. 2, the message flow 300 shown in FIG. 3, and the message flow 400 shown in FIG. 4. The transceiver 535 can be implemented as a single integrated circuit (e.g., using a single ASIC or FPGA) or as a system-on-a-chip (SOC) that includes different modules for implementing the functionality of the transceiver 535. The MME 510 also includes a processor 540 and a memory 545. The processor 540 can be used to execute instructions stored in the memory 545 and to store information in the memory 545 such as the results of the executed instructions. Some embodiments of the processor 540 and the memory 545 are therefore able to perform actions described in the message flow 200 shown in FIG. 2, the message flow 300 shown in FIG. 3, and the message flow 400 shown in FIG. 4.

The neutral host gateway 515 includes a transceiver 550 for transmitting and receiving signals. The transceiver 550 can implement one or more interfaces to entities internal to or external to the neutral host network 500, as discussed herein. Some embodiments of the transceiver 550 are therefore able to transmit and receive messages described in the message flow 200 shown in FIG. 2, the message flow 300 shown in FIG. 3, and the message flow 400 shown in FIG. 4. The transceiver 550 can be implemented as a single integrated circuit (e.g., using a single ASIC or FPGA) or as a system-on-a-chip (SOC) that includes different modules for implementing the functionality of the transceiver 550. The neutral host gateway 515 also includes a processor 555 and a memory 560. The processor 555 can be used to execute instructions stored in the memory 560 and to store information in the memory 560 such as the results of the executed instructions. Some embodiments of the processor 555 and the memory 560 are therefore able to perform actions described in the message flow 200 shown in FIG. 2, the message flow 300 shown in FIG. 3, and the message flow 400 shown in FIG. 4.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for implementation in a local authentication, authorization, and accounting (AAA) server in a neutral host network that provides services supported by any one or more of multiple Participating Service Providers (PSPs) to user equipment in an unlicensed frequency band, the method comprising:
determining, at the local AAA server, that a session involving the user equipment is to be detached from the neutral host network;
transmitting, from the local AAA server to a neutral host gateway in the neutral host network, a first message to initiate session detach of the session involving the user equipment.

2. The method of claim 1, wherein transmitting the first message comprises transmitting at least one of an abort session request to terminate the session or a re-authentication request to terminate a service data flow supported by the session.

3. The method of claim 1, further comprising:
receiving, at the local AAA server prior to establishing the session, at least one of a local policy established for the neutral host network or a PSP policy prescribed by one of the multiple PSPs.

4. The method of claim 3, wherein the local policy or the PSP policy indicates a time limit associated with the session involving the user equipment.

5. The method of claim 4, further comprising:
monitoring, at the local AAA server, an elapsed time for the session involving the user equipment, and
wherein determining that the session involving the user equipment is to be detached from the neutral host network comprises determining that the elapsed time has exceeded the time limit associated with the session.

6. The method of claim 1, further comprising:
receiving, at the local AAA server from a first external AAA associated with a first PSP that supports the session with the user equipment, a second message indicating that the session is to be detached, and
wherein transmitting the first message comprises transmitting the first message in response to receiving the second message.

7. The method of claim 1, wherein the session involving the user equipment is a guest session involving a user equipment that does not have a subscription to receive services supported by a second PSP, and further comprising:
receiving, at the local AAA server from a second external AAA associated with the second PSP, a second message indicating that the user equipment has established a subscription with the second PSP, and
wherein transmitting the first message comprises transmitting the first message to initiate session detach of the guest session in response to receiving the second message.

8. A local authentication, authorization, and accounting (AAA) server for implementation in a neutral host network that provides services supported by any one or more of multiple Participating Service Providers (PSPs) to user equipment in an unlicensed frequency band, the local AAA server comprising:
a processor configured to determine that a session involving the user equipment is to be detached from the neutral host network;
a transceiver configured to transmit, to a neutral host gateway in the neutral host network, a first message to initiate session detach of the session involving the user equipment.

9. The local AAA server of claim 8, wherein the transceiver is configured to transmit at least one of an abort session request to terminate the session or a re-authentication request to terminate a service data flow supported by the session.

10. The local AAA server of claim 8, wherein the transceiver is configured to receive, prior to establishing the session, at least one of a local policy established for the neutral host network or a PSP policy prescribed by one of the multiple PSPs, and wherein the local AAA server further comprises:
a memory to store the at least one of the local policy or the PSP policy.

11. The local AAA server of claim 10, wherein the local policy or the PSP policy indicates a time limit associated with the session involving the user equipment.

12. The local AAA server of claim 11, wherein the processor is configured to monitor an elapsed time for the session involving the user equipment, and wherein the processor is configured to determine that the session involving the user equipment is to be detached from the neutral host network in response to the elapsed time exceeding the time limit associated with the session.

13. The local AAA server of claim 8, wherein the transceiver is configured to receive, from a first external AAA associated with a first PSP for supporting the session with the user equipment, a second message indicating that the session is to be detached, and wherein the transceiver is configured to transmit the first message in response to receiving the second message.

14. The local AAA server of claim 8, wherein the session involving the user equipment is a guest session involving a user equipment that does not have a subscription to receive services supported by a second PSP, and wherein the transceiver is configured to receive, from a second external AAA associated with the second PSP, a second message indicating that the user equipment has established a subscription with the second PSP, and wherein the transceiver is configured to transmit the first message to initiate session detach of the guest session in response to receiving the second message.

15. A neutral host network configured to provide services supported by any one or more of multiple Participating Service Providers (PSPs) to user equipment in an unlicensed frequency band, the neutral host network comprising:
a neutral host gateway configured for communication with at least one external network;
a mobility management entity (MME); and
a local authentication, authorization, and accounting (AAA) server configured to determine that a session involving the user equipment is to be detached from the neutral host network and transmit, to the neutral host gateway, a first message to initiate session detach of the session involving the user equipment.

16. The neutral host network of claim 15, wherein the first message is at least one of an abort session request to terminate the session or a re-authentication request to terminate a service data flow supported by the session.

17. The neutral host network of claim 15, wherein the local AAA server is configured to monitor an elapsed time for the session involving the user equipment and determine that the session involving the user equipment is to be detached from the neutral host network in response to the elapsed time has exceeding a time limit associated with the session.

18. The neutral host network of claim 15, wherein the local AAA server is configured to receive from a first external AAA associated with a first PSP that supports the session with the user equipment, a second message indicating that the session is to be detached, and wherein the local AAA server is configured to transmit the first message in response to receiving the second message.

19. The neutral host network of claim 15, wherein the session involving the user equipment is a guest session involving a user equipment that does not have a subscription to receive services supported by a second PSP, and wherein the local AAA server is configured to receive, from a second external AAA server associated with the second PSP, a third message indicating that the user equipment has established a subscription with the second PSP, and wherein the local AAA server is configured to transmit the first message to initiate session detach of the guest session in response to receiving the third message.

20. The neutral host network of claim 15, wherein the neutral host gateway is configured to transmit a fourth message to the MME in response to receiving the first message from the local AAA server, and wherein the MME is configured to perform session detach for the session in response to receiving the fourth message.
